(19) United States
(12) Patent Application Publication
(10) Pub. No.: US 2008/0235134 A1
(43) Pub. Date: Sep. 25, 2008

(54) Worldwide Money Express Service

(76) Inventor: Gabriel O. Obadan, Pasadena, CA (US)

Correspondence Address: LAW OFFICES OF J.F. LEE, 17800 CASTLETON STREET, SUITE 383, CITY OF INDUSTRY, CA, 91748, US

(21) Appl. No.: 12/132,159

(22) Filed: Jun. 3, 2008

Related U.S. Application Data
(63) Continuation-in-part of application No. 11/198,573, filed on Aug. 8, 2005.

(51) Int. Cl. G06Q 20/00

(52) U.S. Cl. 705/39

(57) ABSTRACT

Worldwide Money Express Service contemplated herein is a business method that provides a door-to-door cash delivery service to its Users through a network of independent licensed drivers who receive cash daily from the service provider and physically deliver the amount requested by the Users to them in person wherever they may be at any point in time and the service provider electronically or physically deducts the amount plus fees from the User's bank or other account before or after the cash delivery is completed.

### STATEMENT OF RELATED APPLICATION

This is a CIP (Continuation-In-Part) application of a previously-filed parent application, Ser. No. 11/198,573, having original filing date of Aug. 8, 2005, with a pending Office Action date of Jan. 14, 2008.

### STATUTORY SUBJECT MATTER

The present invention is a statutory subject matter for granting a patent, because it produces a useful, concrete and tangible result, per State Street Bank & Trust v. Signature Financial Group case (47 USPQ.2d; 1998). The requirement of “within the technological arts” was overturned by USPTO's own Ex Parte Lundgren (BPAI 2005). As a result, it does not matter if the process is within the traditional technological arts or not.

Present invention no doubt produces a useful, concrete and tangible result of financial consequences to users of present invention.

As such, present invention falls squarely within the meaning of the statutory subject matter.

### FIELD AND BACKGROUND OF THE INVENTION

The present invention relates generally to a method of doing business for door-to-door cash delivery service which uses a network of independent contractors known as Agents/Drivers to deliver cash, money order, gift certificate or other financial instruments/tools to intended recipients on a worldwide basis.

Prior art patent/application known to Applicant disclosed none of the business novelty points contained in present CIP application.

Specifically, U.S. patent application number 2003/002979 (“Hansen 979”) does not constitute an anticipating prior art for the following reasons.

Present invention requires the employment of field agent, as driver to physically deliver the money to recipient, either domestically or internationally.

Hansen 979 has NO such element.

Hansen 979 disclosed and claimed a money transfer system implemented by a host computer. In paragraph 12 of Hansen 979, it provides the payment options of, among others, hand delivery, which is not regarded as Hansen 979's invention. And the payment option is NOT the network of field agents who are contracted by service center to drive vehicles and physically deliver money to the designated recipients.

### DETAILED DESCRIPTION OF PRESENT INVENTION

Users (Clients) of the service may use telephone, cellular phone, computer, two-way radio, telegram or any other medium of communication to request the delivery of the money from an agent or driver of the service provider to access User's bank accounts (checking or savings), for example, credit card accounts, investment accounts or any other type of money account.

After money is withdrawn from User's accounts, the money is delivered to the User/Client through a network of independent delivery drivers employed by the service provider. The requested amount plus an agreed fee are electronically deducted from the User's account by the service provider. This deduction can be done either before or after the delivery.

For example, a User may make a delivery request by placing a call to request the delivery of $100 (one hundred U.S. dollars) to him/her at a specific location, without the User having to physically or personally go to an ATM either in the residential neighborhood of the user, or near the work place, or any other place that the user usually goes, to complete the transaction. The network of drivers employed by the service provider will run the errand to retrieve money from ATM, or even the bank, and deliver the money to the designated recipient.

Each driver each day may be given specific sums of money by the service provider for distribution or delivery, and the cash is packaged in envelopes in the denominations of $20, $50 or $100.

Each delivery transaction is regarded as completed after the driver employed by the service provider has physically handed over the requested cash to the User/Client or their designated beneficiary and the amount requested plus a fee, usually 10% of the principal, would be electronically deducted from the User's bank, credit, or other financial account, or by advanced payment of a check or cash equivalent.

The service provider may maintain a database of its customers, so that the User is registered with the service provider, thus establishing a business relationship. Such business relationship may be terminated by service provider or by user when communicated to the other party, if there are fraudulent behaviors.

The money retrieving and delivery service provided herein is done on a 24/7 basis, resulting in maximum convenience and time-saving and safety to its users, especially if making the effort to withdraw money from user's bank and causing the delivery of money is in dangerous neighborhood or at night or other inconvenient times.

The money delivery service contemplated herein can also serve to provide the need for obtaining short-term unsecured personal or business loans, if the User so desires. Such arrangement greatly alleviates the need for User to go through complicated loan or banking procedures and allows them to obtain needed money, while the repayment can be made over an agreed period of time, by electronic deduction of the loan principal plus a specified and agreed upon interest charge.

The User applies for the services contemplated herein by contacting service provider and, if qualified, a “Customer Account Number” (CAN) is assigned to the User/Client, and an agreed monthly “Service Access Fee” is charged to the User. In this type of delivery request made by User having CAN account, money can be delivered to anyone in the world who may not be a customer or client of the service provider.

The hallmark of person-to-person and door-to-door service for delivery of money, or other financial tools, to persons designated by User/Client, on a 24/7 and worldwide basis, is made possible by the network of agents/drivers employed by service provider as stated herein.

The unique door-to-door cash delivery service contemplated herein also include a web-based service of Gift Certificate, containing individual confirmation number, printed out from the Internet, and such Gift Certificate is then delivered to recipient's places as designated by user.

A user of present service provider can purchase the Gift Certificate, say for $300, by simply picking up the phone, or use any communication devices, and inform the service representatives at the call-center to order the Gift Certificate with the express intention of having the Gift Certificate delivered to a friend, relative or business associates at any location in the world, in exchange for cash.

Upon receiving the order, the service provider informs one of its Agents/Drivers living within proximity of the recipient's town, city, state/province, and download and print two copies of the Gift Certificate from the provider's website and take the equivalent amount of cash from the Agent/Driver's bank account and deliver the money and certificate to the recipient.

After arriving at the recipient's place, the Agent/Driver requests for proper identification from recipient, such as driver's license, passport or other identification paper generally acceptable in the local area, and a confirmation number given to the recipient by the service provider for that particular transaction.

If the Agent is satisfied that the recipient is indeed the intended person, the two copies are then given to the recipient to sign and the Agent/Driver keep one signed copy, while the recipient keeps one copy. Throughout the transaction, the Agent/Driver is on the phone with provider's call center representative.

Upon completion of the transaction, the equivalent amount of cash (for example, $300) is handed over to the recipient. In this kind of Gift Certificate transaction, service provider does not use its own money to facilitate the Certificate-to-cash delivery transaction, but relies upon the Agent/Driver's own money. The service provider charges its customers a flat rate delivery charge per transaction and shares the amount with Agents/Drivers.

The service provider does not engage in cash-for-cash transactions but rather uses its own Gift Certificate as the product purchased by its customers with the understanding that the certificate will be exchanged for cash given to the recipient.

The service provider contemplated herein can also use the services of other service providers, such as Western Union and Money Gram to send money to compensate its Agents/Drivers after these people have completed their deliveries anywhere in the world using their own monies to insure against fraudulent claims by Agents/Drivers. After delivery of the cash pursuant to the ordered Gift Certificate, the Agents/Drivers will be reimbursed by the service provider plus their share of delivery charges on a daily basis through electronic money transfer.

What is claimed is:

1. A method of financial services and money distribution for both domestic and international recipients, comprising:
A service provider with a database that will be constantly updated as the roster of users who request and receive service rendered herein;
A plurality of field agents contracted with said service provider to perform delivery wherein each agent/driver may be given money by service provider for distribution to recipients;
Communication means between said service provider and said field agents to convey service requests made by subscription users;
Said service provider withdraws requested amount of money from its own bank account to enable the delivery of money and electronically deduct the request amount plus an agreed percentage of service charge from subscription users' bank, credit or other financial account; and,
Transportation means by field agents to deliver money to the recipients as designated by subscription users of said service provider.

2. The method of financial services and money distribution of claim 1, wherein the means of communication further comprise of the use of traditional landline phones, cell phones, pager, email, and facsimile and the agent/driver shall check the proper identification paper of the recipient to ascertain the delivery is done correctly.

3. The method of financial services and money distribution of claim 2, wherein the plurality of field agents will be given specific sums of money each day by the service center and the cash is packaged in envelops in $20, $50 of $100.

4. The method of financial services and money distribution of claim 3, wherein subscription user can receive money from service provider if requested by another person using the service.

5. The method of financial services and money distribution of claim 3, wherein the requested money delivery transaction can be a business or personal loan if such loan request is made to and approved by the service provider, having the delivery fee and service charge deducted over a period of time.

6. A method of doing business in which Gift Certificates with confirmation numbers can be downloaded and printed from service provider's website on the Internet, or retrieved by any financial institution, so that the recipient can receive cash for the amount stated on the Gift Certificate, in exchange for the Gift Certificate bought by user.

7. A method of doing business in which users of a network of agents/drivers, acting as independent contractors to the service provider, will distribute Gift Certificate or other financial instructions ordered by customers/users at any location for delivery to designated recipient and such Gift Certificate will be converted into cash on the spot or at a later date, when the cash is first advanced by the agent/driver's own money, who will then be reimbursed by service provider plus their share of delivery charge on a daily basis through electronic money transfer.

8. A method of doing business as in claim 7, wherein a qualified user will be given a Customer Account Number that enables the initiation of delivery transaction on a worldwide basis and reduces the chances of fraudulent transaction after the service request to deliver Gift Certificate or cash is authenticated by confirmation of said Customer Account Number from User.

9. A method of doing business as in claim 7, wherein the service provider uses the services of other delivery systems such as Western Union or Money Gram to send or receive money and for the exclusive use of its agents/drivers and for reimbursement of its agents/drivers when they complete the delivery transaction of Gift Certificate to the recipient.
